(19) United States
(12) Patent Application Publication
(10) Pub. No.: US 2006/0067685 A1
(43) Pub. Date: Mar. 30, 2006

(54) Method and arrangement for determining the dispersion of an optical transmission link

(75) Inventor: Erich Gottwald, Holzkirchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/236,086

(22) Filed: Sep. 27, 2005

(30) Foreign Application Priority Data
Sep. 28, 2004 (DE) 10 2004 047 021.9

(51) Int. Cl. H04B 10/08

(52) U.S. Cl. 398/25

(57) ABSTRACT

The invention relates to a method and an arrangement for determining the dispersion of an optical transmission link. By determining the signal quality, the bit error rate is measured for a modulated data signal depending on the modulation frequency of a noise signal (STS). The dispersion coefficient of the transmission link is calculated on the basis of the resulting discrete minima of the bit error rates. These measurements can take place advantageously during the operation of the data transmission. The method also provides additional information about the quality of the data transmission by determining the non-linear phase shift.

### CROSS REFERENCE TO RELATED APPLICATIONS

This application claims priority to the German application No. 10 2004 047 021.9, filed Sep. 28, 2004 and which is incorporated by reference herein in its entirety.

### FIELD OF INVENTION

The invention relates to a method and an arrangement for determining the dispersion of an optical transmission link.

### SUMMARY OF THE INVENTION

The range and capacity of optical transmission systems for long-range communications technology are limited inter alia by signal distortions which are caused by the dispersion in the transmission fiber. The standard single-mode fibers (SSMF) that are often used have a dispersion coefficient of approximately 17 ps/(nm*km) in the wavelength window of 1550 nm. With channel data rates of 2.5 Gbit/s, it is possible to implement dispersion-limited regenerator intervals of approximately 1000 km without compensating measures. Since the range decrease is inversely proportional to the square of the channel data rate, 10 Gbit/s and 40 Gbit/s result in regenerator intervals of approximately 70 km and approximately 3 km respectively. The use of dispersion-compensating measures is therefore essential for most 10-Gbit/s systems and practically all 40-Gbit/s systems in order to avoid signal distortions.

Dispersion compensation in optical transmission links is often achieved by means of compensation fibers which are advantageously accommodated in the optical repeaters in the transmission link. Another possibility provides for including dispersion-compensating elements at the end of a transmission link. In the publications by Tsuda et al., “Second- and Third-Order Dispersion Compensator Using a High-Resolution Arrayed-Waveguide Grating”, IEEE Photonics Technology Letters, (1999) Vol. 11, No. 5, P. 569, an arrayed waveguide grating. (AWG) is used in order to compensate for dispersion-related runtime differences in the data signal. Bragg fiber gratings for dispersion compensation are disclosed in K.-M. Feng, V. Grubsky, D. S. Starodubov, J.-X. Cai, A. E. Willner, J. Feinberg, “Tunable nonlinearly-chirped fiber Bragg grating for use as a dispersion compensator with a voltage-controlled dispersion”, OFC Technical Digest. (1998), paper TuM3, P. 72 and P. L. Maso, J. A. J. Fells, R. V. Penty and I. H. White, “Optical communication system performance using fibre Bragg grating dispersion compensators”, ECOC Technical Digest (1994), P. 435, and K. O. Hill, S. Theriault, B. Malo, F. Bilodeau, T. Kitagawa, D. C. Johnson, J. Albert, K. Takiguchi, T. Kataoka and K. Hagimoto, “Chirped in-fibre Bragg grating dispersion compensators: Linearisation of dispersion characteristic and demonstration of dispersion compensation in 100 km, 10 Gbit/s optical fibre link”, Electronics Letters, (1994), Vol. 30, No. 21, P. 1755.

A precise knowledge of the dispersion of the entire transmission link is important in the dimensioning of the dispersion-compensating elements, particularly when designing an optical transmission link which has high data rates.

In order to determine the overall dispersion of an optical transmission link, the prior art cites an approach by M. Tomizawa, Y. Yamabayashi, Y. Sato and T. Kataoka, “Nonlinear influence on PM-AM conversion measurement of group velocity dispersion in optical fibres”, Electronics Letters, (1994), Vol. 30, No. 17, P. 1434, in which a signal is modulated e.g. by an external phase modulator (PM). The PM signal is converted into an amplitude modulation (AM) by the dispersion of the fiber link (PM-AM conversion). On the basis of the degree of the conversion, it is possible to make statements about the required tracking of the compensation.

The U.S. patent application US 2002/0044322 A1 discloses a method for determining the dispersion of an optical transmission link, said method being based on the multiplexing of optical subcarriers (optical subcarrier multiplexing). In this case, the baseband signals and the subcarrier signals are modulated on a carrier signal by means of a two-arm Mach-Zehnder modulator on the sending side. The respective frequencies of the two subcarriers are established as part of this activity. The signal powers on the first and second subcarrier frequencies are then measured. The dispersion for a data channel is then determined on the basis of the ratio of the measured powers, without the need to demodulate the baseband.

The U.S. Pat. No. 5,033,846 discloses an arrangement for determining the dispersion in a monomode fiber. As part of this activity, a cw signal is modulated with a modulation signal or noise signal of adjustable frequency. The frequency of the modulation signal is varied in order to ascertain the transfer function (“AM frequency response”) of the transmission link. The dispersion is calculated from the frequency at a minimum of the transfer function.

The same method is used in WO 98/57138 for determining the non-linear refractive index coefficient n₂, in which the dispersion is also ascertained as a link parameter. In this case, the light of a laser is amplitude-modulated using a noise signal. While the modulation frequency is varied, the shift of the transmission characteristic curve |S₁₂| for different input light powers is ascertained at the end of the transmission link using a network analyzer and an evaluation unit. The non-linear refractive index coefficient n₂ is calculated from the shift of the |S₁₂| minima depending on the modulation frequency. The overall dispersion can also be determined for known light wavelengths by evaluating the minima of the transmission characteristic curve. However, the described method has the disadvantage that the measurement cannot take place during the data transmission in an optical network. The measurement can only be carried out in a separate optical transmission link having a receiver which includes a network analyzer and an additional evaluation unit.

The invention addresses the problem of specifying a method and a measuring arrangement, said measuring arrangement being as simple as possible, for determining the dispersion of an optical transmission link while data transmission is in progress.

A method and an arrangement for solving this problem is described in the claims.

The invention has the advantage that the overall dispersion or the non-compensated residual dispersion can be measured on both a transmission link and in an optical network during operation.

A further advantage of the invention is that, in the case of point-to-point connections, only one modulation unit is required for all wavelengths on the sending side. The same applies to PXCs (optical cross-connects or photonic cross-connects) for each celestial direction.

The method offers the further advantage that, on the receiving side, it is only necessary to read out the error rate or the number of errors which were corrected by Forward Error Correction (FEC). Other statements about the signal quality are established by utilizing eye pattern and histogram methods, for example.

A further advantage of the invention is that a measurement run for all active wavelengths provides the residual dispersion.

The invention has the further advantage that, without using additional components such as a network analyzer and a power measuring unit, it is also possible to measure the non-linear phase (formula 3, P. 8) of an optical transmission link, thereby allowing inferences in relation to the quality of the data transmission. Using the non-linear phase, it is then possible to specify, for example, how many regenerator-free link sections can be integrated into the system and how far the power level can be varied towards higher values before the transmission degrades again due to non-linearities.

Further advantages of the invention are that no additional data signal errors occur when using an error-correcting code, the data signal information is not compromised by the measuring, and the signal quality is simultaneously checked in parallel with the measured variable.

The invention will now be explained with reference to an exemplary embodiment and with reference to FIGS. 1 and 2.

### BRIEF DESCRIPTION OF THE DRAWINGS

FIG. 1 shows a possible embodiment of the invention for a point-to-point connection of an optical transmission link, and

FIG. 2 shows the transfer function depending on the modulation frequency of an auxiliary signal. The resulting minima are clearly identifiable.

### DETAILED DESCRIPTION OF INVENTION

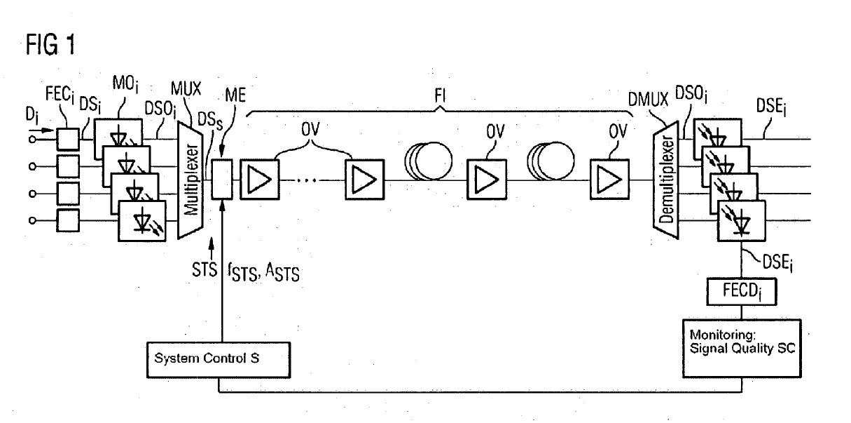

In an optical transmission link such as that which is illustrated schematically in FIG. 1, the data signals Dᵢ to be transmitted are initially protected in an FEC encoder FECᵢ. A plurality of optical carrier signals are then modulated with the encoded data signals DSᵢ in modulators MOᵢ, and the optical data signals DSOᵢ are combined by the multiplexer MUX to form a multiplex signal DSₛ on the sending side. In the modulation unit ME, a sinusoidal noise signal STS is modulated (preferably amplitude-modulated) onto all of the optical data signals DSₛ together, said optical signals being output by the multiplexer MUX. The term modulation here is intended also to include equally acting effects that are caused by superimposition. Consequently, the signal quality is degraded and the number of bit errors which must be corrected by the FEC is increased. The noise signal STS can be varied in both frequency f_{STS} and in amplitude A_{STS}. Both modulation parameters are set by means of a system control S. After passing through an optical transmission link FI, which includes a plurality of optical repeaters OV, and splitting of the modulated multiplex signal by a demultiplexer DMUX into individual optical data signals DSOᵢ and reconversion into electrical data signals DSEᵢ, the signal quality is checked on the receiving side either for an individual channel or for all channels in parallel. If error correction is used, the signal quality checking takes place by measuring the bit error rate (BER) in an FEC decoder FECDᵢ. If no error correction is used, the signal quality can be carried out by measuring eye patterns or by histogram measuring methods. All of these methods are used for detecting interferences on the data signal. The BER has a special significance in this case. It is derived directly from the number of corrected bits of the FEC, and is forwarded by the decoders to the system control S, which is installed as standard for quality monitoring.

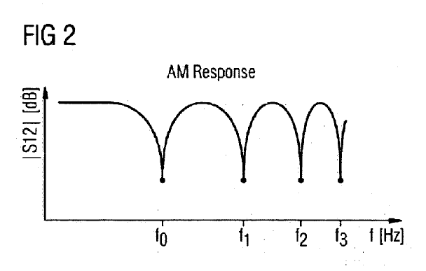

In order to determine the dispersion, the BER of the received data signals DSEᵢ is recorded depending on the modulation frequency f_{STS}. In this case, the following applies as a rule: if a light which has been amplitude-modulated with the frequency f is conducted through a dispersive element, the amount of the transfer function |S₁₂| in [dB] indicates characteristic minima for specific discrete frequencies fₖ when plotted logarithmically as shown in FIG. 2. Assuming that no non-linearities are present, the total dispersion Dₜₒₜ can be calculated from the position of the k-th minimum by means of the following equation (see e.g. M. Schiess, H. Carlden, ‘Evaluation of the chirp parameter of a Mach-Zehnder intensity modulator’, Electronic Letters, (1994) 30, 18, P. 1524):

$$\frac{π {λ}^{2}}{c} \cdot {D}_{tot} \cdot {f}_{k}^{2} = ( 2 k - 1 ) \frac{π}{2} \qquad ( 1 )$$

c speed-of light in a vacuum in [m/s]

λ wavelength of light in a vacuum in [m]

k=1, . . . ,n running index of the minima

Dₜₒₜ is usually specified in [ps/nm]. It applies that:

Dₜₒₜ[ps/nm]=1000*Dₜₒₜ[s/m

On the basis of the formula (1), it is clear that the total dispersion Dₜₒₜ of a dispersive element or a dispersive transmission link can be determined by applying the modulation frequency f_{STS} at the position of a minimum k with a known light wavelength λ. The interference with is caused by the signal STS disappears for the frequencies fₖ for which the BER is minimal. Therefore a direct connection is established between the minima of the bit errors or the corrected errors as a function of the modulation frequency and the total dispersion.

Performing a dispersion measurement is briefly described in the following.

On the sending side, either an individual optical data signal DSOᵢ is modulated before the multiplexer MUX or all channels are modulated concurrently by inserting the modulation unit ME after the multiplexer MUX. In order to prevent additional interferences on the data signal, the modulator should not have a chirp, since a PM-AM conversion already takes place as a result of the dispersion.

The measurement can be started either with modulation frequencies f_{STS} which are clearly greater than the data rate of the transport network, or with modulation frequencies which are very small (in the range of a few times 10 MHz), since the sinusoidal noise frequency is practically unattenuated for low modulation frequencies (see FIG. 2). At the beginning of the measurement, the modulation amplitude A_{STS} is selected such that the error rate BER does not exceed tolerable values of e.g. 10⁻³ to 10⁻⁵ for all channels.

If the measurement is carried out for an individual channel, the modulation frequency f_{STS} is reduced or increased in accordance with an initial condition (typically in the 100 MHz to 1 GHz raster) for the channel concerned and the bit error rate of this channel is measured. The modulation amplitude A_{STS} is adjusted such that the BER for the selected channel remains roughly constant. At the same time, it is checked whether the critical BER is exceeded on one of the other channels. If yes, the measuring run is restarted from the beginning using an altogether smaller modulation amplitude A_{STS}. If no, the modulation frequency f_{STS} is decreased or increased further (in accordance with a selected initial condition) and the modulation amplitude A_{STS} of the selected channel is held constant while that of the other channels is adjusted. The method is repeated until such time as a minimum for the BER is found.

If the measurement is carried out in parallel for all channels, all channels are modulated together and the modulation frequency f_{STS} is either decreased or increased in accordance with an initial condition as in the case of the individual measurement. The bit error rates for all channels are measured concurrently. The modulation amplitude A_{STS} is always adjusted for all channels in such a way that the BER upper limit is not exceeded. These steps are repeated until such time as a minimum for the BER is found.

If a plurality of BER minima are recorded depending on the modulation frequency f_{STS}, as indicated in FIG. 2, then it is also possible to determine the non-linear phase from the frequency minima shift with reference to the measuring method from WO 98/57138. It is possible to deduce the non-linear phase shift φ_{chirp} from the frequency shift of at least two minima as shown in the following formulae:

$$\begin{matrix}\frac{π {λ}^{2}}{c} \cdot {D}_{tot} \cdot {f}_{k}^{2} + {φ}_{chirp} = ( 2 k - 1 ) \frac{π}{2} \\ with & ( 2 ) \\ tan ( {φ}_{chirp} ) = 2 \cdot {L}_{eff} \cdot γ \cdot {P}_{mean} \\ and & ( 3 ) \\ γ = 2 \cdot π \cdot \frac{{n}_{2}}{λ} \cdot {A}_{eff} & ( 4 )\end{matrix}$$

where tan(φ_{chirp}) is the measured shift,

L_{eff} is the effective length of the glass fiber in [m]

A_{eff} is the effective cross-sectional area of the optical fiber in [m²] and

Pₘₑₐₙ is the average power in [W] and

n₂ is the non-linear refractive index coefficient in [m²/W]

γ is an auxiliary parameter here.

The knowledge of the non-linear phase and therefore the product L_{eff}·γPₘₑₐₙ also provides information about the power response of the overall system. If the product L_{eff}·γγPₘₑₐₙ for a given data rate and fiber type exceeds a threshold value (maximal value for the non-linear phase φ_{chirp}^{max}), the interference of the non-linear effects becomes too great and the data transport in the optical transmission link is compromised. Therefore the measurement of the non-linear phase gives a specific indication of how far the power level in the transmission link can be increased without exceeding φ_{chirp} ^{max}.

Where the fiber parameters are known, the measurement of the non-linearity is carried out in a channel using a network analyzer and a power measuring device, and can take place during operation. The accuracy of the determining of n₂ can be increased by carrying out the measurement for a plurality of power values Pₘₑₐₙ.

When using the invention in an optical network, each output of an optical cross connect (XC) can be provided with a modulation unit ME. As a result, it is possible to determine the dispersion on all active wavelengths between the relevant cross connects (XC) and the end points (identified by the receivers RXi (i=1, . . . ,n)) or as far as the next regenerator of the link concerned. The method can therefore be used for dimensioning the dispersion-compensating elements when constructing optical networks or also for verifying the dispersion of any link sections. In technical terms, all that is required is the installation of the modulation unit in a free slot.

1. A method for determining a dispersion of an optical transmission link, wherein a data signal is transmitted from a sender to a receiver, the method comprising:
modulating the data signal on the sending side using an adjustable noise signal having an adjustable frequency;
determining the signal quality of the received data signal on the receiving side;
changing the frequency of the noise signal and redetermining the signal quality, wherein this procedure is repeated until having an optimal frequency of the noise signal, wherein a maximal signal quality or a minimal interference of the noise signal is established; and
determining the dispersion from the optimal frequency of the noise signal.

2. The method as claimed in claim 1, wherein the signal quality is determined using bit errors of the received data signal or using an eye pattern of the received data signal or using a histogram of the received data signal.

3. The method as claimed in claim 2, wherein the signal quality is determined by recording a histogram of the received data signal.

4. The method as claimed in claim 2, wherein the data signal which is to be sent is protected by an error correction and/or error detection code, and wherein the bit error rate is determined on the receiving side with the aid of the error correction and/or error detection code.

5. The method as claimed in claim 4, wherein the amplitude of the noise signal and therefore the modulation index is only changed so far as the correcting capabilities of an error correction code which is used are not exceeded.

6. The method as claimed in claim 1, wherein the dispersion (assuming an absence of non-linearities) is calculated according to
$$\frac{π {λ}^{2}}{c} \cdot {D}_{tot} \cdot {f}_{STS , k}^{2} = ( 2 k - 1 ) \frac{π}{2}$$
where
f_{STS,k} is the frequency of the noise signal in [Hz],
c is the speed of light in a vacuum in [m/s],
λ is the wavelength of light in a vacuum [m] and
k=1, . . . , M, . . . n is the running index for the recorded minima of the bit error rate, wherein
Dₜₒₜ in [s/m] is the total dispersion of the optical transmission link.

7. The method as claimed in claim 2, wherein the dispersion (assuming an absence of non-linearities) is calculated according to
$$\frac{π {λ}^{2}}{c} \cdot {D}_{tot} \cdot {f}_{STS , k}^{2} = ( 2 k - 1 ) \frac{π}{2}$$
where
f_{STS,k} is the frequency of the noise signal in [Hz],
c is the speed of light in a vacuum in [m/s],
λ is the wavelength of light in a vacuum [m] and
k=1, . . . , M, . . . n is the running index for the recorded minima of the bit error rate, wherein
Dₜₒₜ in [s/m] is the total dispersion of the optical transmission link.

8. The method as claimed in claim 4, wherein the dispersion (assuming an absence of non-linearities) is calculated according to
$$\frac{π {λ}^{2}}{c} \cdot {D}_{tot} \cdot {f}_{STS , k}^{2} = ( 2 k - 1 ) \frac{π}{2}$$
where
f_{STS,k} is the frequency of the noise signal in [Hz]
c is the speed of light in a vacuum in [m/s],
λ is the wavelength of light in a vacuum [m] and
k=1, . . . ,M, . . . n is the running index for the recorded minima of the BER.
Dₜₒₜ in [s/m] is the total dispersion of the optical transmission link.

9. The method as claimed in claim 5, wherein the dispersion (assuming an absence of non-linearities) is calculated according to
$$\frac{π {λ}^{2}}{c} \cdot {D}_{tot} \cdot {f}_{STS , k}^{2} = ( 2 k - 1 ) \frac{π}{2}$$
where
f_{STS,k} is the frequency of the noise signal in [Hz],
c is the speed of light in a vacuum in [m/s],
λ is the wavelength of light in a vacuum [m] and
k=1, . . . ,M, . . . n is the running index for the recorded minima of the bit error rate, wherein
Dₜₒₜ in [s/m] is the total dispersion of the optical transmission link.

10. The method as claimed in claim 2, wherein a plurality of minima of the bit error rates are recorded, said bit error rates being dependent on the frequency of the noise signal, and wherein the non-linear phase shift in the optical transmission link is determined from a shift of these minima.

11. The method as claimed in claim 3, wherein a plurality of minima of the bit error rates are recorded, said bit error rates being dependent on the frequency of the noise signal, and wherein the non-linear phase shift in the optical transmission link is determined from a shift of these minima.

12. The method as claimed in claim 4, wherein a plurality of minima of the bit error rates are recorded, said bit error rates being dependent on the frequency of the noise signal, and wherein the non-linear phase shift in the optical transmission link is determined from a shift of these minima.

13. The method as claimed in claim 1, wherein the modulation of all output signals of a wavelength multiplexer is performed jointly in a modulator on the sending side.

14. The method as claimed in claim 2, wherein the modulation of all output signals of a wavelength multiplexer is performed jointly in a modulator on the sending side.

15. The method as claimed in claim 1, wherein the frequency and/or the amplitude of the noise signal is controlled by an evaluation unit on the receiving side via a service channel of the system control.

16. The method as claimed in claim 2, wherein the frequency and/or the amplitude of the noise signal is controlled by an evaluation unit on the receiving side via a service channel of the system control.

17. A method for determining the dispersion of an optical transmission link,
in which a data signal is transmitted from a sender to a receiver,
wherein
the data signal is modulated on the sending side using an adjustable noise signal which has an adjustable frequency,
the signal quality of the received data signal is determined on the receiving side,
the frequency of the noise signal is varied and the signal quality is measured again,
this procedure is repeated until a maximal signal quality or a minimal interference of the noise signal is established in the case of an optimal frequency of the noise signal, and
the dispersion is calculated from the optimal frequency of the noise signal.

18. An arrangement for determining a dispersion of an optical transmission link having a wavelength multiplexer on the sending side, the arrangement comprising:
a modulation unit for amplitude-modulating a data signal using a noise signal, wherein the modulation unit is arranged on the sending side, and wherein the modulation unit is configured in such a way that it can be adjusted in frequency and amplitude;
a measuring unit for capturing the signal quality of the data signal; and
an evaluation unit, wherein the measuring unit and the evaluation unit are arranged on the receiving side, and wherein the evaluation unit is connected to the modulation unit via a service channel of a system control for the purpose of controlling and adjusting the frequency and/or the amplitude of the noise signal.

19. The arrangement as claimed in claim 18, wherein the modulation unit is designed as a plug-in module arrangable at any position in front of or behind the multiplexer at the beginning of the optical transmission link.
